(19) United States
(12) Patent Application Publication
(10) Pub. No.: US 2015/0035239 A1
(43) Pub. Date: Feb. 5, 2015

(54) Powered Hand Tool Having A Clamping Device For A Tool

(71) Applicant: C. & E. Fein GmbH, Schwaebisch Gmuend-Bargau (DE)

(72) Inventor: Curdin Maissen, Fehraltorf (CH)

(21) Appl. No.: 14/517,510

(22) Filed: Oct. 17, 2014

Related U.S. Application Data
(63) Continuation of application No. PCT/EP2013/057013, filed on Apr. 3, 2013.

(30) Foreign Application Priority Data
Apr. 17, 2012 (DE) 102012007926.5

(51) Int. Cl. B24B 23/04; B23D 51/10; B24B 45/00

(52) U.S. Cl. CPC B24B 23/04; B24B 45/006; B23D 51/10
USPC 279/141

(57) ABSTRACT

The invention relates to a powered hand tool comprising a housing that comprises a spindle head having a tool spindle that can be driven about its longitudinal axis, in particular can be driven in an oscillatory rotary manner, the tool spindle having a tool-side end comprising a holding portion for a tool to be driven, and comprising a clamping device that comprises a fastening element, the clamping device having a clamping configuration, in which the tool can be fixed to the tool spindle by means of the fastening element, and having a release configuration, in which the tool is releasable, and the clamping device is able to be switched over between the clamping configuration and the release configuration by means of a unidirectional positioning movement.

### CROSSREFERENCES TO RELATED APPLICATIONS

This application is a continuation of international patent application PCT/EP2013/057013, filed on Apr. 3, 2013 designating the U.S.A., which international patent application has been published in German language and claims priority from German patent application 10 2012 007 926.5, filed on Apr. 17, 2012. The entire contents of these priority applications are incorporated herein by reference.

### BACKGROUND OF THE INVENTION

The invention relates to a powered hand tool comprising a housing that comprises a spindle head having a tool spindle that can be driven about its longitudinal axis, in particular can be driven in an oscillatory rotary manner, the tool spindle having a tool-side end comprising a holding portion for a tool to be driven, and comprising a clamping device that comprises a fastening element, the clamping device having a clamping configuration, in which the tool can be fixed to the tool spindle by means of the fastening element, and having a release configuration, in which the tool is releasable.

Such a hand tool is known, for instance from WO 2005/102605 A1. The known hand tool has a working spindle for driving a tool, the tool being able to be fixed to a tool-side end of the working spindle by means of a fastening element. Additionally provided is a displacement means, for displacing the fastening element between a release position and a clamping position. For the purpose of actuating the displacement means, the known hand tool has a clamping lever, which comprises an eccentric that can be swivelled between a first position and a second position, which may correspond, for instance, to the clamping position and the release position of the fastening element.

The known hand tool can enable a tool to be changed rapidly and easily, without the need for a separate aid such as, for instance, a wrench, screwdriver, hexagonal key or similar for releasing and fixing the tool. In particular, it does not require any special tools to enable the tool to be fixed to the working spindle.

A user can switch over the displacement means between the clamping position and the release position, by means of defined swivel movements, for instance once in the clockwise direction and once in the anti-clockwise direction. When in the release position, the clamping lever can assume a position in which it projects beyond a silhouette of the hand tool. For example, the clamping lever may project significantly beyond a housing of the hand tool. This may be inconvenient during transporting of the hand tool, for instance if a transport case or similar, having defined receiving contours for the housing of the hand tool, is used. In order to get round this disadvantage, the user may simply swivel the lever from the release position back into the clamping position, such that it is again integrated into the silhouette of the hand tool. When the known hand tool is used again, the clamping lever can again be brought from the clamping position into the release position. Finally, after a tool has been received, the latter can be fixed to the working spindle by once again swivelling the clamping lever from the release position into the clamping position.

### SUMMARY OF THE INVENTION

In view of this, it is a first object of the invention to disclose a powered hand tool that, allows an easy tool changing without the use of separate aids.

It is a second object of the invention to disclose a powered hand tool that is easy to manufacture and has a reliable design.

It is a third object of the invention to disclose a powered hand tool that can be operated in a simple manner.

It is a third object of the invention to disclose a powered hand tool that allows to avoid superfluous positioning movements of the clamping device are insofar as possible.

According to one aspect these and other objects are achieved by a powered hand tool comprising:

a housing having a spindle head;

a tool spindle;

a drive for driving said tool spindle about a longitudinal axis thereof;

wherein said tool spindle comprises a tool-side end having a holding portion for holding a tool to be driven, and further comprises a clamping device having a fastening element, said clamping device having a clamping configuration, in which said tool can be fixed to said tool spindle by means of said fastening element, and having a release configuration, in which said tool is releasable from said tool spindle;

wherein said clamping device comprises an unidirectional positioning element being configured for switching over between said clamping configuration and said release configuration by means of an unidirectional movement.

According to the invention a user can now alternately bring the clamping device into the clamping configuration and into the release configuration, by means of a substantially unidirectional actuating movement. Thus, the transition between the clamping configuration and the release configuration need no longer be effected by means of actuating movements in substantially opposite directions.

Thus, when the clamping device is in the clamping configuration, the substantially unidirectional positioning movement can effect a changeover to the release configuration. Conversely, a clamping device in the release configuration can be changed back over to the clamping configuration by means of the substantially unidirectional positioning movement.

It is understood that, in principle, another movement may be superposed on the substantially unidirectional positioning movement. For example, a substantially unidirectional axial positioning movement may additionally also comprise radial components, for instance at least partial rotations or swivelling movements. In the case of various designs, in principle, such superposed movements may also be in opposite directions to each other. In other words, the transition from the clamping configuration to the release configuration and back to the clamping configuration may thus comprise a respectively unidirectional (axial) positioning movement on which, however, a swivelling movement in alternating directions is superposed. However, it is likewise conceivable, in principle, for a superposed swivel movement also to be effected unidirectionally.

The positioning movement may be initiated by an actuating movement of the user. It is conceivable to couple the positioning movement to the actuating movement in such a manner that exclusively unidirectional actuating movements are to be applied by the user.

Moreover, it is understood that the unidirectional positioning movement may additionally comprise a restoring movement, which, however, may be effected automatically, without intervention by the user. The restoring movement, in principle, is opposite in direction to the positioning movement. The restoring movement may be used, for instance, to finally shift the clamping device, or its components, into a clamping position corresponding to the clamping configuration, or into a release position corresponding to the release configuration, after the clamping device has been disengaged from the previous configuration by means of the positioning movement.

According to a further design of the hand tool, the clamping device has a positioning element, which is displaceable relative to the tool spindle and which, when in the clamping configuration, assumes a first defined relative position and, when in the release configuration, assumes a second defined relative position in respect of the tool spindle.

The relative position may be, in particular, a defined axial position along the longitudinal axis. In other words, the positioning element may be moved in a defined manner by a displacement, along the longitudinal axis, that is initiated by means of the unidirectional positioning movement. In the reciprocal transition between the first defined relative position and the second defined relative position, the positioning element may be moved back and forth along the longitudinal axis. Thus, the essentially unidirectional positioning movement can ultimately effect displacements of the positioning element that are mutually opposite in direction. This may be effected, in particular, by the unidirectional positioning movement acting in combination with the restoring movement.

The first defined relative position and the second defined relative position may also, in principle, comprise a defined rotary position of the positioning element relative to the tool spindle. As already explained above, however, it is also conceivable that, in the reciprocal transition between the release configuration and the clamping configuration, the rotary position of the positioning element changes continuously or in a step-wise manner. It is also conceivable, however, that precisely one first define rotary position is assigned to the first defined relative position, and a second rotary position is assigned to the second defined relative position.

The positioning element may be such that it can be coupled to the fastening element. For example, the positioning element, when in the clamping configuration, may constrain and bias the fastening element in the direction of the holding portion of the tool spindle. According to one design, the positioning element may be jointly integrated with the fastening element, and in particular realized as a single piece. It is also conceivable, however, for the positioning element and the fastening element to be indirectly or directly coupled to each other, and in particular coupled to each other in a releasable manner. For example, the fastening element, when in the release configuration, may be releasable from the positioning element, in order to simplify receiving of a tool.

According to a further design, a guide path is provided, which has at least one first extremum and at least one second extremum, the first defined relative position of the positioning element, when in the clamping configuration, being defined by the at least first extremum, and the second defined relative position of the positioning element, when in the release configuration, being defined by the at least one second extremum.

In other words, the guide path may have, for instance, local and global maxima, which alternate with each other and, in particular, are connected to each other by minima. It is understood that, if viewed inversely, the guide path may likewise comprise local and global minima, which are disposed alternately in relation to each other and, in particular, are connected by maxima.

The guide path may be realized, for instance, as a guide groove. A guide groove may delimit the guide path on two sides, for instance by both flanks of the groove. However, the guide path may also comprise a one-sided flank. In such a case, the guide path may be realized in that the positioning element is biased by a force in the direction of the flank.

The guide path may be realized so as to be at least partially form-fitting. Alternatively or additionally, the positioning element may be held in the guide path by the action of force.

According to a development, the guide path is realized as a full-perimeter guide path, the positioning element, in the case of repeated positioning movement, executing overall a rotation about the tool spindle.

In other words, the guide path may, for instance, extend once around the longitudinal axis, or encircle the latter. The guide path may, in principle, be realized on a circumference of the tool spindle or of the positioning element. The full-perimeter guide path may comprise a full-perimeter guide groove or a full-perimeter guide flank. The rotation of the positioning element may result from rotary components or swivel components that are superposed, respectively, on the unidirectional positioning movement. In other words, in the case of each positioning movement (acting in combination with each restoring movement) the positioning element can effect a defined rotation about the longitudinal axis.

In an alternative design, the guide path is realized as a re-entrant guide path, the positioning element, in the case of repeated positioning movement, being swivelled alternately back and forth in respect of the tool spindle.

Unlike the full-perimeter guide path, the re-entrant guide path does not extend around the longitudinal axis of the tool spindle. The tool spindle is not “encircled”. For example, the re-entrant guide path may be realized as a “heart-shaped” gate on a circumferential side of the tool spindle or of the positioning element. Other designs are conceivable.

The full-perimeter guide path may define a multiplicity of rotary positions for the positioning element. This applies, in particular, if the full-perimeter guide path has a plurality of first maxima and, corresponding thereto, a plurality of second maxima. The sum of the first extrema and second extrema may amount to the number of defined rotary positions of the positioning element.

The re-entrant guide path may normally have precisely one first maximum and precisely one second maximum. During passage along the guide path, a first minimum has to be overcome in the transition from the first maximum to the second maximum. In the case of the further movement from the second maximum to the first maximum, a second minimum has to be overcome. In other words, in the case of the reentrant guide path, the positioning element as it goes round does not execute a movement that is identical but in opposite directions, but instead executes various partial movements, the start points and end points of which correspond mutually.

In a preferred development, the guide path is realized on the tool spindle, the positioning element having at least one guide element, which can be moved along the guide path.

The guide element may be realized, for instance, as a pin or guide profile on the positioning element and extend, for instance, substantially radially outwards on a circumference of the positioning element. Preferably, the guide path is realized on an inner circumference of the tool spindle.

It is understood that, in an alternative design, the guide path may be realized on the positioning element, the at least one guide element being disposed on the tool spindle.

According to a further aspect of the hand tool, the positioning element can be coupled to a disengaging element, which is realized to selectively disengage the positioning element from the first relative position or the second relative position.

In other words, the user can indirectly or directly actuate the disengaging element in order to initiate the positioning movement of the positioning element. In the case of such a design, any rotation of the positioning element, for example, may be effected without disturbance to the user. The disengaging element may be realized to be moved along the longitudinal axis. The first relative position may correspond to the at least one first extremum. The second relative position may correspond to the at least one second extremum.

In an advantageous design, a spring element is provided, which acts upon the positioning element in the direction of the at least one first extremum and the at least one second extremum.

In this way, the restoring movement can be effected automatically by a force applied by means of the spring element. The spring force may be directed, in particular, towards a drive-side end of the tool spindle. The drive-side end of the tool spindle is the end that faces away from the tool-side end. For the purpose of transition between the clamping configuration and the release configuration, the positioning element may be guided, by means of the unidirectional positioning movement, against the force of the spring element, for example over the respective minima that connect the first extremum and the second extremum. If the spring element acts upon the positioning element, the guide path may in principle be realized so as to be one-sided, i.e. having only one guide flank.

According to a development of this design, the fastening element, when in the clamping configuration, is acted upon by means of the spring element in the direction of the holding portion of the tool spindle.

In this way, the spring element can both define the position of the positioning element and act upon the fastening element in such a manner that the tool, when in the clamping configuration, is securely fixed to the tool spindle.

According to a further design, the fastening element and the positioning element can be coupled to each other.

According to a further aspect, the hand tool has an actuating means, which has an actuating element that can be coupled to the positioning element for the purpose of displacing the latter.

By means of the actuating element, the user can apply an actuating movement that initiates the substantially unidirectional positioning movement. In other words, the user, in principle, can act likewise unidirectionally upon the positioning element, via the actuating element. By contrast, actuating mechanisms known in the prior art require actuating movements in opposite directions in order to bring clamping devices reciprocally into the clamping configuration and the release configuration. The actuation can be simplified.

According to a development of this design, the actuating element is realized to boost an actuating force applied by a user.

The actuating element may be designed, for instance, in consideration of the lever principle or the principle of the inclined plane. This means, for example, the actuating movement may comprise a comparatively large actuating travel for a comparatively small actuating force. In the case of the positioning element, for instance, a comparatively small positioning travel, paired with a comparatively large positioning force, can be obtained through appropriate stepping-up of the force, or stepping-down of the travel. In this way, for instance, the spring element can be adequately dimensioned for the tool, when in the clamping configuration, to be securely fixed in the tool spindle.

According to a further design, the actuating element may be realized, for instance, as an actuating slide or as an actuating lever.

It is understood that, alternatively, the user may also act indirectly or directly (axially) upon the positioning element in another manner. For this purpose, the actuating element may be realized, for instance, as an actuating button.

Moreover, the actuating element may also be realized, for example, as an actuating wheel. Such a wheel, in principle, may be designed to be rotatable about an axis disposed parallel to or perpendicular to the longitudinal axis of the tool spindle. An actuating wheel whose axis is disposed parallel to the longitudinal axis may comprise, for instance on its end face, an axial guide contour that acts in an appropriate manner upon the positioning element for the purpose of displacing the latter. An actuating wheel whose axis is disposed substantially perpendicularly in relation to the longitudinal axis may comprise a radial guide contour on its circumference. Such an actuating wheel may be understood, for instance, as a “full-perimeter” actuating lever.

According to a development of the hand tool, the fastening element, when in the release configuration, as compared with its position when in the clamping configuration, is displaced axially along the longitudinal axis in relation to the tool spindle.

Such an axial displacement capability of the fastening element provides for a multiplicity of designs of suitable tool receivers. For example, a tool that is to be fastened may have an open tool receiving contour and be fed substantially laterally (radially) to the tool spindle. In such a case, it is not necessary for the fastening element, when in the release configuration, to be released from the tool spindle. Rather, the tool can be fed laterally and then securely fixed to the tool spindle by bringing the clamping device into the clamping configuration.

Other designs are conceivable. For example, the tool may have a closed receiving contour or receiving opening. Such a tool can be fixed in that the fastening element, when in the clamping configuration, is not only displaced axially along the longitudinal axis, but is also rotated relative to the receiving opening of the tool. Such a relative rotation may result in an at least partial overlap, for instance if the tool receiving opening and the fastening element have mutually corresponding silhouettes (profiles). In this way, for the purpose of fastening, the tool can be fed substantially axially, and overcome the fastening element. Nevertheless, the result is that, in the clamping configuration, the tool is secured axially in position in a form-fitting manner.

According to a further design, the fastening element, when in the release configuration, can be released from the tool spindle.

Such a design is disclosed, for instance, in WO 2005/102605 A1. Similar designs, having releasable fastening elements, are disclosed by EP 2 017 036 A1 and DE 20 2009 001 439 U1. Such designs may also be advantageously combined with the clamping device, which can be switched over by means of the unidirectional positioning movement.

It is understood that the above-mentioned features and those yet to be explained in the following may be applied, not only in the respectively specified combination, but also in other combinations or singly, without departure from the scope of the invention.

### BRIEF DESCRIPTION OF THE DRAWINGS

Further features and advantages of the invention are given by the following description of a plurality of preferred exemplary embodiments, with reference to the drawings, wherein:

FIG. 1 shows a perspective view of a hand tool;

FIG. 2 shows a simplified partial lateral view of a tool spindle with a tool, in a partially sectional representation;

FIG. 3 shows a lateral section through a hand tool, for instance according to FIG. 1, in the region of the transmission head;

FIG. 4 shows a simplified schematic partial view of a tool from above;

FIG. 5a shows a greatly simplified schematic partial representation of a developed guide path;

FIG. 5b shows a simplified partial representation of a positioning element, having guide elements, which can act in combination with, for instance, the guide path according to FIG. 5a;

FIGS. 6a to 6d show greatly simplified schematic partial representations of a mechanism having a guide path, a positioning element and a disengaging element, in various relative positions;

FIGS. 7a, 7b show two lateral simplified views of a first actuating means, in differing relative positions;

FIG. 8 shows a greatly simplified lateral representation of a fastening element, modified in comparison with the representation in FIGS. 7a and 7b;

FIG. 9 shows a further greatly simplified representation of a further fastening element, modified in comparison with the representation in FIGS. 7a and 7b; and

FIG. 10 shows a further simplified schematic representation of a guide path, with positions of a guide element indicated exemplarily.

### DESCRIPTION OF PREFERRED EMBODIMENTS

FIG. 1 shows a perspective representation of a hand power tool, which is denoted as a whole by 10. The hand tool 10 may be a powered hand tool, in particular a hand tool driven by an electric motor. The hand tool 10 may be designed, for instance, as an oscillatory driven power tool.

A hand tool having an oscillatory rotary drive may be used for a multiplicity of sawing tasks, cutting tasks, filling tasks, grinding tasks or the like. Usually, such hand tools (oscillatory tools) have swivel frequencies in the range of from approximately 10,000 to 25,000 oscillations per minute. The oscillations may be effected, for instance, with a small swivel angle that is, for example, between 0.5° and 7°. It is also understood, however, that the hand tool 10 may also be realized, for instance, as a hand tool having an intermittently or fully rotary drive. Such a hand tool may be designed, for instance, as an angle grinder, hand saw or similar.

The hand tool 10 has a housing 12, adjoining which there is a spindle head 14. It is understood that the spindle head 14 may be an integral component part of the housing 12. It is likewise conceivable for the spindle head 14 to be flange-mounted onto the housing 12 in a modular manner. A power transmission means, for instance an eccentric coupling drive (not represented in FIG. 1), may be accommodated in the housing 12 (and in the spindle head 14). The housing 12 may accommodate a motor, for example an electric motor or a compressed-air motor. Moreover, energy storage devices may be accommodated in the housing 12. This may be the case, for instance, if the hand tool 10 is a hand tool 10 that can be operated without a mains electric power supply, in particular a hand tool 10 having a battery pack.

Mounted in the spindle head 14 is a tool spindle 16, whose end on the tool side projects outwardly through the housing 12 in the region of the spindle head 14. The tool spindle 16 can execute an output motion, for example a rotary oscillation or a rotation about a longitudinal axis 18. The oscillatory rotary output motion that ensues in the case of a preferred design of the hand tool 10 as an oscillatory tool is indicated by a double arrow, denoted by 20.

A tool 24 is accommodated on the tool spindle 16 and secured by means of a fastening element 22. The tool 24 is, for example, a sawing tool or a cutting tool having a spatially delimited toothing. However, as mentioned above, the tool 24 may also be designed as a grinding tool, polishing tool or similar. The tool 24 may have an offset.

A circle line, denoted by 26, indicates that substantially rotationally symmetrical tools may also be used, for example abrasive discs, circular saw blades or similar. Circular tools 26 may be used particularly if the hand tool 10 is designed to drive the tool spindle 16 rotationally or intermittently. The housing 12 may be realized, for instance, in the shape of a rod, and have an operating switch 28 in an upper region that faces away from the tool 24. A user can thus hold and guide the hand tool 10 in a rear region, and start or stop the tool 10 via the operating switch 28. At a rear end, which faces away from the spindle head 14, the hand tool 10 additionally has a power supply line 30, which is represented only partially in FIG. 1. By means of the supply line 30, the hand tool 10 can be connected, for instance to a power supply network, for example to an electric power supply network or a compressed-air network. As already mentioned above, the hand tool 10 may also be operated without a mains electric power supply, for example by means of a battery pack.

In general, hand tools having an oscillatory rotary output can be used in a highly flexible manner. However, this high degree of flexibility may mean that the tool 24 has to be changed comparatively frequently. In the case of known hand tools, a changing operation requires, for example, special tools or similar aids. A possible approach for simplifying a tool change may be envisaged in enabling a tool change to be effected solely by means of “on-board means”. Such designs can be found, for instance, in WO 2005/102605 A1, EP 2 017 036 A1 or DE 20 2009 001 439 U1. All of the said documents show hand tools in which a tool change is possible without separate aids. In the case of the respective designs, particular consideration is given to hand tools having an oscillatory rotary output motion. Such hand tools, particularly in the region of their tool receivers, have higher loads than tools of comparable size that have, for instance, exclusively rotational output motions. An oscillatory rotary drive of a tool frequently involves higher impulsive or jolt-type loads. The said documents disclose means for displacing a fastening element. In a respective clamping position, it is provided to act upon the fastening element with a force of sufficient magnitude to enable the tool to be held securely on the tool spindle. The required force is applied, in particular, by means of a spring element. Provided for the user, for the purpose of actuation, are various swivel levers that can be swivelled, for instance, between two defined positions in order to provide a clamping position and a release position for the fastening element.

The following explains various exemplary designs of hand tools 10, the tool clamping devices of which may be designed so as to be basically similar to those of WO 2005/102605 A1, EP 2 017 036 A1 and DE 20 2009 001 439 U1. Provided as an alternative for the user, however, is an alternative operating logic that allows the clamping device to be actuated in a simple and comprehensible manner.

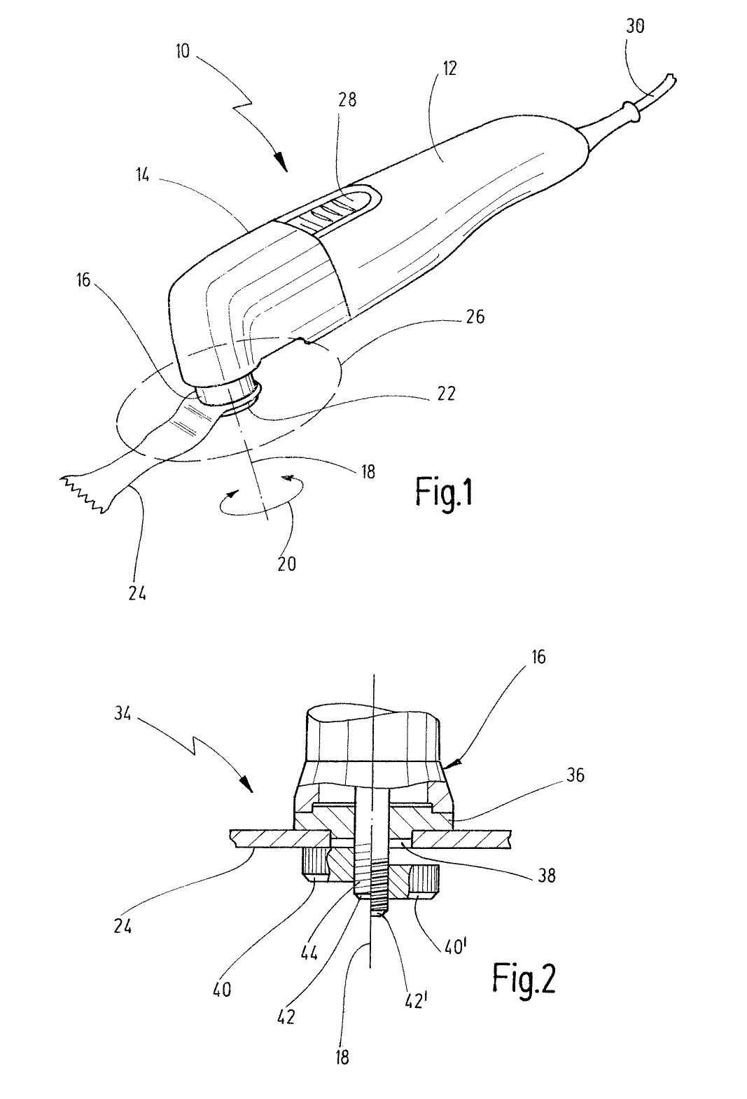

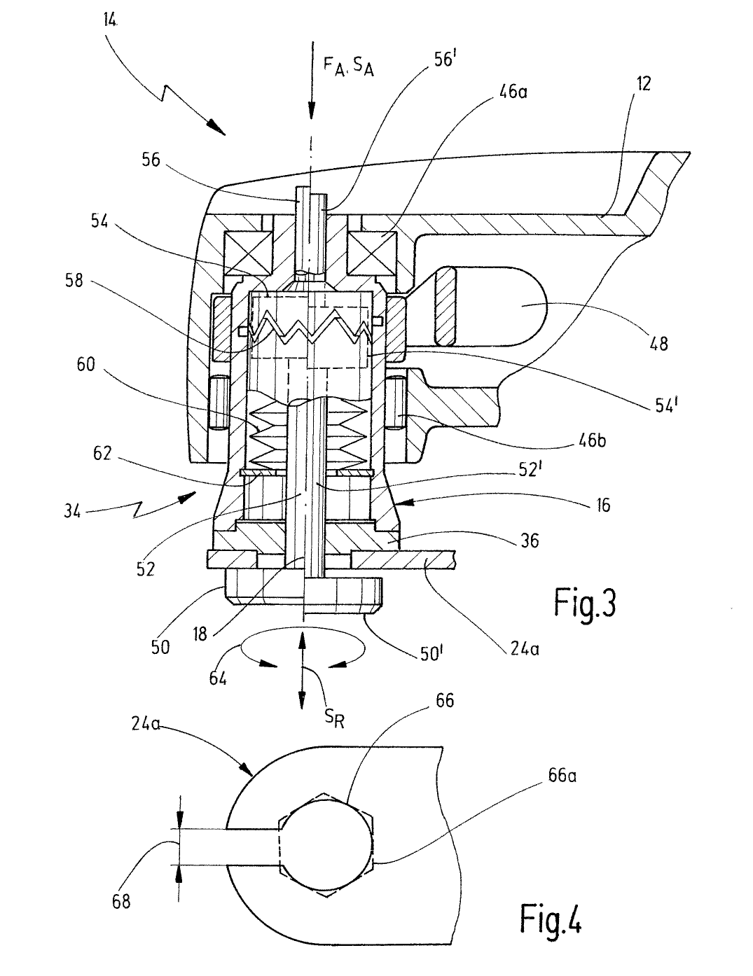

FIG. 2 shows, exemplarily, a partial side view of a tool spindle 16 in the region of its tool-side end. The tool spindle 16 may be used, for instance, in the case of the hand tool 10 according to FIG. 1. Also depicted in FIG. 2, at least partially, is a clamping device 34, the basic structure of which may correspond, for instance, to that of DE 20 2009 001 439 U1. A more detailed exemplary, alternative design of the clamping device 34 is depicted, for instance, in FIG. 3.

The tool spindle 16 in FIG. 2 is represented in section in the region of its tool-side end. The tool spindle 16 has a holding portion 36, against which the tool 24 can come into bearing contact. For example, the holding portion 36 may have a projection 38, which can centre the tool 24 on the holding portion 36. Moreover, the projection 38 and a receiving opening of the tool 24 may be designed, for instance, to correspond in such a manner that the projection 38 locks the tool 24 against rotation about the longitudinal axis 18.

The clamping device 34 has an associated fastening element 40, which may be realized, for example, as a nut or knurled nut. The fastening element 40 is carried on a shaft 42. The fastening element 40 may be fixed to the shaft 42 by means of a thread 44. The fastening element 40 and the shaft 42 are in a clamping position, such that the clamping device 34 as a whole is in a clamping configuration. Additionally indicated in FIG. 2, by 40′ and 42′, are so-called release positions of the fastening element 40 and of the shaft 42. The positions indicated by 40′ and 42′ correspond to the release configuration of the clamping device 34. When in the release configuration, as compared with its position when in the clamping configuration, the fastening element 40 is displaced axially away from the holding portion 36.

According to the exemplary design shown in FIG. 2, the fastening element 40 (here: clamping nut or knurled nut) can be released from the shaft 42, to enable the tool 24 to be removed. This can be effected, in principle, with only a small amount of force, since the fastening element 40, when in the release configuration, is not biased against the tool 24 by means of a biasing force. In order to receive a new tool 24, the fastening element 40 can thus simply be released and, after the new tool 24 has been placed on or pushed on, can simply be screwed back on to the shaft 42 without much effort. The transition of the clamping device 34 from the release configuration to the clamping configuration again results in an axial displacement of the fastening element 40 accommodated on the shaft 42, but this time in the direction towards the holding portion 36. This may involve biasing, which may be applied, for instance, by means of a spring element, not represented in greater detail in FIG. 2.

FIG. 3 shows a larger portion of a lateral view of a hand tool 10, for instance according to FIG. 1, in the region of the spindle head. The design shown in FIG. 3 may be used, in principle, to complement the components represented in FIG. 2.

The tool spindle 16 is accommodated in the spindle head 14 by means of a drive-side bearing 46a and an output-side bearing 46b. Accommodated between the bearings 46a, 46b is an eccentric fork 48, which is connected to the tool spindle 16 in a rotationally fixed manner. The eccentric fork 48 is realized to convert a drive motion of a drive motor (not represented in FIG. 3) into an oscillatory rotary output motion of the tool spindle 16, cf. arrow 20 in FIG. 1. The eccentric fork 48 may be designed, for instance, to be coupled to an eccentrically revolving portion of a motor shaft that acts upon the eccentric fork 48, for example via a crowned bearing.

The clamping device 34 according to FIG. 3 has a fastening element 50, which is designed, for instance, as a clamping piece. The fastening element 50 is connected to a clamping shaft 52, which is coupled to a positioning element 54 (represented in FIG. 3 merely by broken lines, for illustrative purposes). In addition, there may be an adjoining pressure piece 56 that, for instance, may project through the tool spindle 16 at its drive-side end. The drive-side end of the tool spindle 16 is the end opposite to the toolside end. The positioning element 54 is coupled in a special manner to a guide path 58, which, in this case, is realized on an inner circumference of the tool spindle 16. The guide path 58 is explained in greater detail in the following in connection with FIGS. 5a and 5b.

The positioning element 54 and the guide path 58 may act in combination, for instance, in such a manner that the fastening element 50 can assume two defined axial positions along the longitudinal axis 18. In a manner similar to the representation in FIG. 2, in FIG. 3, likewise, a release position or release configuration of the fastening element 50, clamping shaft 52, positioning element 54 and pressure piece 56 is depicted by a representation in a displaced position, with the references 50′, 52′, 54′ and 56′.

The clamping device 34 according to FIG. 3 additionally has a spring element 60, which may be supported, for instance on a support ring 62 accommodated on the tool spindle 16. The spring element 60 may be realized to bias the positioning element 54 axially in the direction of the clamping position. For the purpose of actuating the positioning element 54, a positioning movement may be applied, which may be characterized, for instance, by a positioning force FA, or a positioning travel sA. The positioning force FA, or positioning travel sA, may be applied, in particular, to the pressure piece 56. In the transition between the clamping configuration and the release configuration, the fastening element 50 may execute a relative movement having the designation sR. A rotation about the longitudinal axis 18, cf. an arrow denoted by 64, may be superposed on the relative displacement.

When in the release position, as compared with its position when in the clamping configuration, the fastening element 50′ is displaced, for instance, in such a manner that a tool can be released from the holding portion 36. This can also be effected, in principle, without the fastening element 50 being fully released from the tool spindle 16. For example, a tool 24a may be used that has a receiving opening 66 provided with a recess, or gap 68 (FIG. 4). The receiving opening 66 is not closed in form. The gap 68 may be matched, for instance, to a diameter of the clamping shaft 52, to allow the tool 24a to be loaded radially. The receiving opening 66 may be, for instance, in the shape of a circle, or circle segment, to allow the tool 24a to be at least centred on the holding portion 36. Moreover, for example, it is also possible to provide a receiving opening, denoted by 66a, that is matched to the holding portion 36 in a form-fitting manner in such a way that the accommodated tool 24a is locked against rotation. For example, the receiving opening 66a is realized as a hexagon. Other geometries are conceivable, in particular polygonal contours, toothed contours, spline contours or similar.

The design of the guide path 58 and that of the positioning element 54 coupled to the latter is explained in greater detail with reference jointly to FIGS. 3, 5a and 5b. The representation in FIG. 5a corresponds to a (flat) development of the full-perimeter guide path 58 according to FIG. 3. The guide path 58 may be realized, for instance, as a guide groove 70 on an inner circumference of the tool spindle 16. Guide elements 72 may be realized on the positioning element 54 (FIG. 5b), which guide elements may be matched to the guide groove 70 in such a manner that the positioning element 54, as it goes along the guide path 58, can execute a defined relative movement in respect of the tool spindle 16. At least one guide element 72, but also a plurality of guide elements 72, may be realized on the positioning element 54. As already mentioned above, it is also possible, conversely, for the guide elements 72 to be realized on the tool spindle 16 and for the guide path 58 to be realized on the positioning element 54. The positioning element 54, only a portion of which is represented in FIG. 5b, may be realized, for instance, as a cylindrical or hollow-cylinder portion that can be indirectly or directly coupled to the fastening element 50 and the pressure piece 56. The fastening element 50, the clamping shaft 52, the positioning element 54 and the pressure piece 56 may be of a single-piece or multi-piece design.

The full-perimeter guide path 58, shown in a non-continuous representation in FIG. 5a, has at least one first maximum 74 and at least one second maximum 76. The first maxima 74 and the second maxima 76 alternate with each other. The first maxima 74 and the second maxima 76 are connected to each other by minima 78. The positioning element 54, as it goes along the guide path 58, can assume various defined relative positions in respect of the tool spindle 16. A position of the guide element at a second maximum 76, which is indicated by 72′, may correspond to the release position, or release configuration, in which, for instance, the fastening element 50 is moved axially away from the holding portion 36 of the tool spindle, to allow the tool to be changed. During the transition in the direction of the clamping configuration, a minimum 78 must be overcome, cf. the guide element 72″ in FIG. 5a. For this, the positioning movement must be used to overcome a spring force FS that is applied, for instance, by the spring element 60 according to FIG. 3. The positioning element 54, after passing through the minimum 78, can in principle be displaced automatically in the direction of the clamping position, or a further second maximum 74, cf. the guide element 72′″. Thus, overall, in the case of the full-perimeter design of the guide path 58 shown in FIG. 5a, a zig-zag movement can be produced for the positioning element 54, with an alternate positioning movement (cf. FA, sA).

The axial positional difference sR between the first maxima 74 and the second maxima 76 describes the resultant travel of the positioning element 54. The resultant travel sR describes an axial positional difference of the positioning element 54 that is obtained in comparison of the first relative position and the second relative position in respect of the tool spindle 16. However, as it goes along the guide path 58 according to FIG. 5a, the positioning element 54 as a whole also undergoes a rotation, which is indicated by the arrow denoted by 64. This rotation is effected about the longitudinal axis 18, cf. also the arrow 64 in FIG. 3. This rotation need not necessarily be transmitted to the fastening element 50. It is conceivable for the fastening element 50 to be coupled to the positioning element 54 only for the purpose of axial driving. This may be effected, for instance, by suitable bearings or linkage joints.

By generating a unidirectional positioning movement that may be applied, for instance, substantially axially and in the direction opposite to the spring force FS, a user can cause the positioning element 54 to move (axially) back and forth. In this way, simplified operation of the clamping device 34 can be achieved.

The representation in FIG. 5a makes clear that flanks of the guide groove 70 are disposed in an oblique or offset manner, at least portionally. With such a design, it can be ensured that the guide elements 72 go along the guide path 58 in a directional manner, cf. the arrow 64. In other words, the repeated unidirectional positioning movement (FA, sA), besides effecting the change between the two (axial) relative positions, cf. the extrema 74, 76, can ultimately effect overall a global lateral turning or rotation of the positioning element 54.

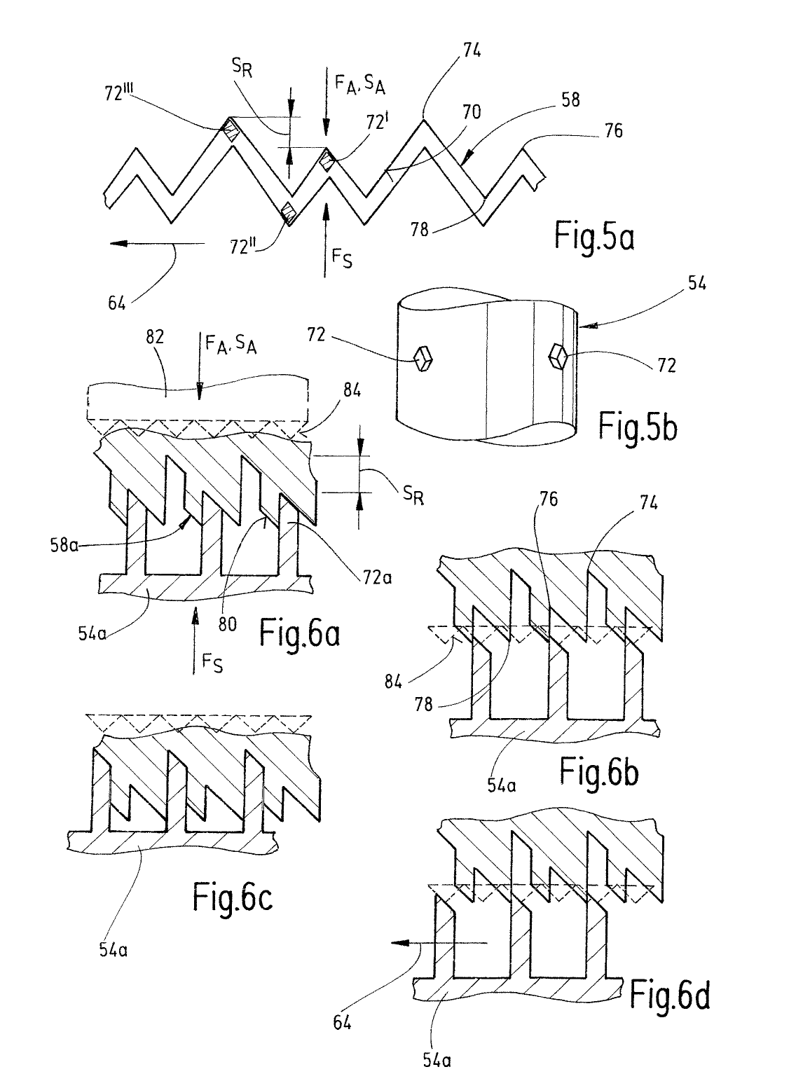

By way of modification, as compared with FIGS. 5a and 5b, FIGS. 6a, 6b, 6c and 6d show an alternative mechanism, in which a switchover of the clamping device 34 between the clamping configuration and the release configuration is likewise rendered possible by means of a unidirectional positioning movement (FA, sA). Provided for this purpose is a guide path 58a, which, likewise, may be realized, for instance, on the circumference of the tool spindle 16. Again, for simplification, a developed representation of the guide path 58a is shown.

The guide path 58a is not realized as a guide groove, but has substantially a one-sided guide contour or flank 80. Also indicated in FIG. 6, in a greatly simplified representation, is a positioning element 54a, which has guide elements 72a that are guided along the guide path 58a. The positioning element 54a may be biased against the guide path 58a by means of a spring force FS. The spring force FS must be overcome by means of the unidirectional positioning movement, to enable the positioning element 54a to be displaced between a release position (FIG. 6a) and a clamping position (FIG. 6c). In a manner similar to the guide path 58 shown in FIG. 5a, the guide path 58a has first maxima 74, second maxima 76 and, disposed between them, minima 78, cf. FIG. 6b.

For the purpose of disengaging the positioning element 54a and shifting it between the release position and the clamping position, a disengaging element 82 is provided, which has a disengagement contour 84 that is realized, for instance, as a toothed contour. With reference to the representation shown in FIG. 3, the disengagement contour 84 may be coupled, for instance, to the pressure piece 56, which then, however, is no longer fixedly connected to the positioning element 54a. The disengaging element 82 may be realized, for instance, as a sleeve, with the disengagement contour 84 realized on the end face of the latter. The unidirectional positioning movement may be initiated by pressing down the disengagement contour 84, cf. arrow FA, sA in FIG. 6a. In FIG. 6b, the disengagement contour 84 is in engagement with the guide elements 72a of the positioning element 54a, and forces these elements away from the second maximum 76 and in the direction of and over the minimum 78. After passing over the minimum 78, the positioning element 54a can automatically assume the clamping position shown in FIG. 6c. As a result of the spring force FS, the guide elements 72a are moved in the direction of the first maximum 74.

The resultant travel sR that ensues in the transition between the release position and the clamping position is indicated in FIG. 6a. The travel sR corresponds, for instance, to an (axial) positional difference between the first maxima 74 and the second maxima 76. Shifting the disengaging element 82 anew initiates a renewed positioning movement and, again, a disengagement of the positioning element 54a out of its assumed position, in the direction of the next defined position. Overall, a step-wise (lateral) movement can be obtained, which is indicated in FIG. 6d by the arrow 64. This movement may have the overall effect of turning the positioning element 54a in relation to the tool spindle 16, if the guide path 58a, the positioning element 54a and the disengaging element 82 are realized to go round in a circle.

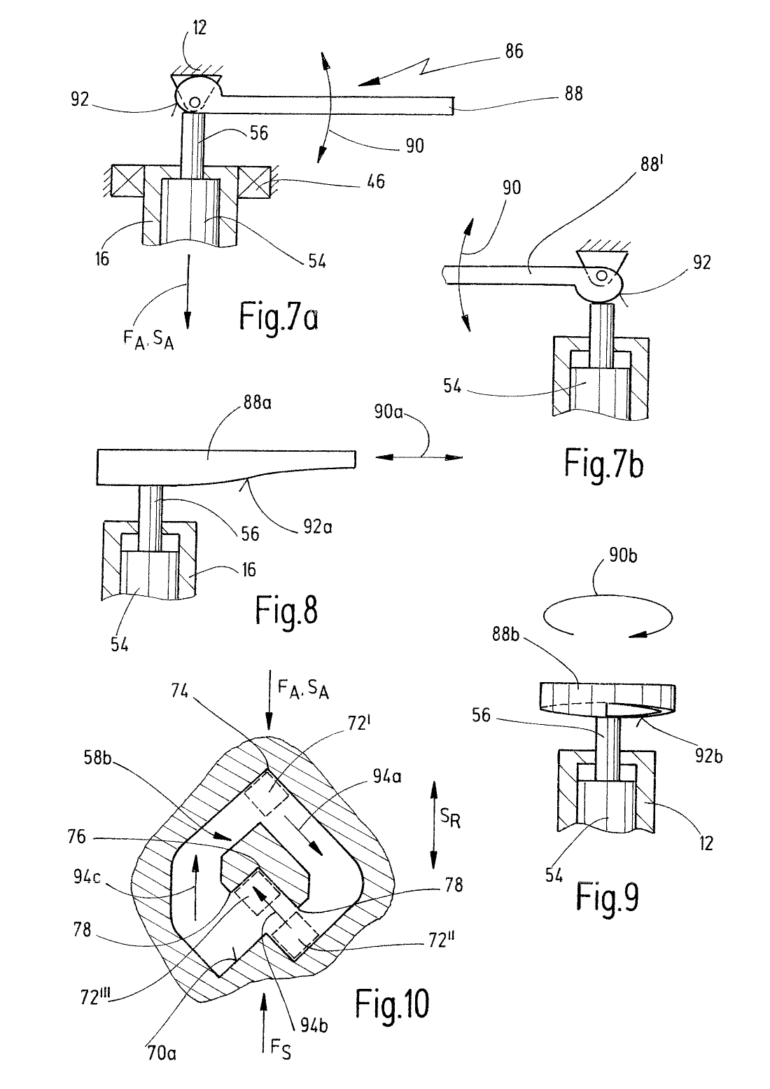

FIGS. 7a, 7b, 8 and 9 depict various designs of actuating means 86, which differ in respect of the actuating elements 88. The actuating means 86 represented in FIG. 7a has an actuating element 88 that is realized, for instance, as a swivel lever. The actuating element 88 can be swivelled about a swivel axis, cf. an arrow denoted by 90. The actuating element 88 has an active face 92 that is realized, for instance, as a cam face or eccentric face. By means of the actuating means 86, the user can directly or indirectly apply the positioning movement, cf. the arrow denoted by FA, sA. For this purpose, the actuating element 88 may be designed to act in combination with the pressure piece 56, via the active face 92. For example, the pressure piece 56 may be coupled to the positioning element 54 accommodated on the tool spindle 16.

In the position shown in FIG. 7b, the positioning element 54 has been shifted relative to its position in FIG. 7a. The actuating element, denoted here by 88′, has been swivelled in relation to its original position. Unlike solutions known in the prior art, the position of the positioning element shown in FIG. 7b does not correspond to a new extreme position, thus for instance the clamping configuration or release configuration, but for instance to a passage over one of the minima 78, cf. FIGS. 5a and 6b. Consequently, swivelling of the actuating element 88′ back into the position shown in FIG. 7a does not result in a new switchover of the clamping device 34. A further transition between the clamping configuration and the release configuration (or vice versa) can be initiated by again swivelling the actuating element 88 into the position indicated in FIG. 7b. Thus, for the user, a definite active direction can be obtained. A unidirectional actuating movement can result in the unidirectional positioning movement.

FIGS. 8 and 9 show alternative designs of actuating element 88a, 88b, in a simplified representation. The actuating element 88a according to FIG. 8 is realized, for instance, as an actuating slide that, for example, can be slid along an arrow denoted by 90a. The actuating element 88a has an active face 92a, which can be used to act upon the pressure piece 56. The actuating element 88a may be accommodated and located in an appropriate manner, for instance on the housing 12 of the hand tool 10.

The actuating element 88b according to FIG. 9 is realized, for example, as a positioning wheel. The actuating element 88b is accommodated so as to be rotatable, cf. an arrow denoted by 90b. The actuating element 88b is accommodated so as to be rotatable about an axis that, for instance, is parallel to the longitudinal axis 18 (FIG. 3), but disposed at a distance from the latter. The actuating element 88b has an active face 92b that is realized, for instance, along an annular portion of an axial end face of the actuating element 88b. For example, the active face 92b has two mutually corresponding, ascending flanks that are offset by approximately 180° in relation to each other. Other designs are conceivable. The clamping device 34 can be brought alternately into the clamping configuration and the release configuration by continuous rotation (here: 180° in each case) of the actuating element 88b.

The actuating means 86 shown in FIGS. 7a, 7d, 8 and 9 may be combined, for example, with the design of the clamping device 34 shown in FIG. 3. Alternatively, it is conceivable to actuate the clamping device 34 according to FIG. 3 directly, by acting upon the pressure piece 56, for instance by means of an actuating button.

By means of an appropriate design of the active faces 92, 92a, 92b, the actuating elements 88, 88a, 88b can have the effect of boosting force. In other words, for instance, an actuating force can be appropriately stepped up in order to achieve a sufficiently high positioning force FA that is capable of overcoming the clamping force FS of the spring element 60.

FIG. 10 shows a further alternative design of a mechanism in which a defined travel between two relative positions is made possible by means of a unidirectional positioning movement (arrow FA, sA). Provided for this purpose is a guide path 58b, having a guide groove or guide contour 70a that is, for instance, “heart-shaped”. Arrows denoted by 94a, 94b and 94c indicate a movement of the guide element 72 along the guide path 58b.

The guide path 58b is designed as a recurrent, or re-entrant, guide path. Unlike, for instance, the full-perimeter guide path 58 according to FIG. 5a, it is not necessary for the recurrent guide path 58b to encircle the longitudinal axis 18 (cf. FIG. 3). Rather, the guide path 58b may be realized, or let in, laterally, for instance on an inner face of the tool spindle 16 or on an outer face of the positioning element 54. The guide path 58b has precisely one first maximum 74 and one second maximum 76. Respectively one minimum 78 is provided between the maximum 74, 76. A travel that ensues during the change between the two maxima 74, 76 is indicated by sR. The travel sR may denote the distance between the two defined relative positions of the positioning element 54 in respect of the tool spindle 16. A guide element denoted by 72′ is located in the first extreme position, which is assigned to the first defined relative position. A guide element denoted by 72″ is located in the region of a minimum 78 that is to be overcome in the transition between the maxima 74, 76. A guide element denoted by 72′″ is located at the second maximum of the guide path 58b, and thus the positioning element 54 can be located in the second defined relative position, for instance the release configuration. The guide elements 72 may be realized on the positioning element 54, according to FIG. 5b.

As already explained above, it is preferred if a spring force is applied to the positioning element 54 and the fastening element 40; 50 in the clamping configuration. It is thus understood that the guide elements 72, when in the clamping configuration, with a received tool 24, need not necessarily contact the first maxima of the guide path 58, 58a, 58b. Rather, there may be a resultant gap, which may be defined, for instance, by a thickness of the received tool. It is likewise understood, however, that the guide paths 58, 58a, 58b may be designed in such a manner that the guide elements 72 may nevertheless pass the maxima 74, in order to be fed to the second maxima 76.

What is claimed is:

1. A powered hand tool comprising:
a housing having a spindle head;
a tool spindle;
a drive for driving said tool spindle about a longitudinal axis thereof;
wherein said tool spindle comprises a tool-side end having a holding portion for holding a tool to be driven, and further comprises a clamping device having a fastening element, said clamping device having a clamping configuration, in which said tool can be fixed to said tool spindle by means of said fastening element, and having a release configuration, in which said tool is releasable from said tool spindle;
wherein said clamping device comprises an unidirectional positioning element having a guide path including at least one first extremum and at least one second extremum, said guide path being configured for switching over between said clamping configuration and said release configuration by means of an unidirectional movement;
wherein said unidirectional positioning element is configured displaceable relative to said tool spindle, and wherein said unidirectional positioning element, when in being said clamping configuration, assumes a first defined relative position and, when being in said release configuration, assumes a second defined relative position in respect of said tool spindle.

2. A powered hand tool comprising:
a housing having a spindle head;
a tool spindle;
a drive for driving said tool spindle about a longitudinal axis thereof;
wherein said tool spindle comprises a tool-side end having a holding portion for holding a tool to be driven, and further comprises a clamping device having a fastening element, said clamping device having a clamping configuration, in which said tool can be fixed to said tool spindle by means of said fastening element, and having a release configuration, in which said tool is releasable from said tool spindle;
wherein said clamping device comprises an unidirectional positioning element being configured for switching over between said clamping configuration and said release configuration by means of an unidirectional movement, and being configured displaceable relative to said tool spindle, and wherein said positioning element, when in being said clamping configuration, assumes a first defined relative position and, when being in said release configuration, assumes a second defined relative position in respect of said tool spindle.

3. The powered hand tool of claim 2, wherein said unidirectional positioning element further comprises a guide path having at least one first extremum and at least one second extremum, said first defined relative position of said positioning element, when being in said clamping configuration, being defined by said at least one first extremum, and said second defined relative position of said positioning element, when in said release configuration, being defined by said at least one second extremum.

4. The powered hand tool of claim 3, wherein said guide path is configured as a full-perimeter guide path, and wherein said unidirectional positioning element, in the case of repeated positioning movements, is configured for executing an overall rotation about said tool spindle.

5. The powered hand tool of claim 3, wherein said guide path is configured as a re-entrant guide path, and wherein said unidirectional positioning element, in the case of repeated positioning movements, is swivelled alternately back and forth in respect of said tool spindle.

6. The powered hand tool of claim 3, wherein said guide path is arranged on said tool spindle, and said unidirectional positioning element has at least one guide element, being configured for moving along said guide path.

7. The powered hand tool of claim 3, further comprising a disengaging element being configured for engaging said unidirectional positioning element for selectively disengaging said unidirectional positioning element from said first relative position or said second relative position.

8. The powered hand tool of claim 3, further comprising a spring element being arranged for biasing said unidirectional positioning element in a direction of said at least one first extremum and said at least one second extremum.

9. The powered hand tool of claim 8, wherein said tool spindle further comprises a holding portion, said said spring element being arranged for biasing said fastening element in the direction of said holding portion of said tool spindle, when being in said clamping configuration.

10. The powered hand tool of claim 3, wherein said fastening element and said unidirectional positioning element are configured for engaging each other.

11. The powered hand tool of claim 3, further comprising an actuating device having an actuating element that can be coupled to said positioning element for displacing said unidirectional positioning element.

12. The powered hand tool of claim 11, wherein said actuating element is configured for boosting an actuating force applied by a user.

13. The powered hand tool of claim 11, wherein said actuating element is configured as an actuating slide or as an actuating lever.

14. The powered hand tool of claim 2, wherein said fastening element, when being in said release configuration, as compared with its position when in said clamping configuration, is displaced axially along said longitudinal axis in relation to said tool spindle.

15. The powered hand tool of claim 3, wherein said fastening element is configured for releasing from said tool spindle, when being in said release configuration.

16. A powered hand tool comprising:
a housing having a spindle head;
a tool spindle;
a drive for driving said tool spindle about a longitudinal axis thereof;
wherein said tool spindle comprises a tool-side end having a holding portion for holding a tool to be driven, and further comprises a clamping device having a fastening element, said clamping device having a clamping configuration, in which said tool can be fixed to said tool spindle by means of said fastening element, and having a release configuration, in which said tool is releasable from said tool spindle;
wherein said clamping device comprises an unidirectional positioning element being configured for switching over between said clamping configuration and said release configuration by means of an unidirectional movement.

17. The powered hand tool of claim 16, wherein said unidirectional positioning element further comprises a guide path having at least one first extremum and at least one second extremum, said first defined relative position of said positioning element, when being in said clamping configuration, being defined by said at least one first extremum, and said second defined relative position of said positioning element, when in said release configuration, being defined by said at least one second extremum.

18. The powered hand tool of claim 17, wherein said guide path is configured as a full-perimeter guide path, and wherein said unidirectional positioning element, in the case of repeated positioning movements, is configured for executing an overall rotation about said tool spindle.

19. The powered hand tool of claim 18, wherein said guide path is configured as a re-entrant guide path, and wherein said unidirectional positioning element, in the case of repeated positioning movements, is swivelled alternately back and forth in respect of said tool spindle.

20. The powered hand tool of claim 18, wherein said guide path is arranged on said tool spindle, and said unidirectional positioning element has at least one guide element, being configured for moving along said guide path.
